(19) United States
(12) Patent Application Publication
(10) Pub. No.: US 2026/0233319 A1
(43) Pub. Date: Aug. 13, 2026

(54) Tooth Flank Machining Device and Tooth Flank Machining Method

(71) Applicant: HONDA MOTOR CO., LTD., TOKYO (JP)

(72) Inventors: Jie XUE, TOKYO (JP); Junichi KUROKAWA, TOKYO (JP); Masayuki ORIHARA, TOKYO (JP); Naoki IWASA, TOKYO (JP); Yu KUBODERA, TOKYO (JP)

(21) Appl. No.: 19/533,799

(22) Filed: Feb. 9, 2026

(30) Foreign Application Priority Data
Feb. 10, 2025 (JP) 2025-019699

(51) Int. Cl. B23F 23/12; B23F 5/04

(52) U.S. Cl. CPC B23F 23/1218; B23F 5/04

(57) ABSTRACT

A tooth flank machining device includes: a first motor that rotates a grinding tool including a tool tooth portion having a thickness smaller than a width of a tooth space of a workpiece gear; a predetermined sensor that outputs a detection signal corresponding to a load of the first motor; a second motor that rotates the workpiece gear; and a control device that controls the first motor based on the detection signal to adjust a lead angle of the grinding tool so that the load in the case where a tooth flank of the rotating workpiece gear is ground by the tool tooth portion falls within an allowable range determined in advance.

### CROSS-REFERENCE TO RELATED APPLICATIONS

This application is based upon and claims the benefit of priority from Japanese Patent Application No. 2025-019699 filed on February 10, 2025, the contents of which are incorporated herein by reference.

### BACKGROUND OF THE INVENTION

### Field of the Invention

The present disclosure relates to a tooth flank machining device and a tooth flank machining method.

### DESCRIPTION OF THE RELATED ART

JP 6030857 B2 discloses a technique relating to a tooth flank machining device. According to JP 6030857 B2, the tooth flank machining device finishes a tooth flank of a high-hardness gear by using a helical teeth grinding wheel.

### SUMMARY OF THE INVENTION

In recent years, there has been a demand for a better technique for a tooth flank machining device including a helical teeth grinding wheel for grinding a gear to be machined.

The present disclosure has the object of solving the above-described problem.

A first aspect of the present disclosure is characterized by a tooth flank machining device that grinds a tooth flank that forms a tooth space of a workpiece gear, the tooth flank machining device comprising: a first motor configured to rotate a grinding tool including a tool tooth portion having a thickness smaller than a width of the tooth space; a predetermined sensor configured to output a detection signal corresponding to a load of the first motor; a second motor configured to rotate the workpiece gear; and a control device configured to control the first motor based on the detection signal to adjust a lead angle of the grinding tool relative to the workpiece gear in a manner so that the load in a case where the tooth flank of the workpiece gear during rotation is ground by the tool tooth portion falls within an allowable range determined in advance.

A second aspect of the present disclosure is characterized by a tooth flank machining method for grinding, using a tooth flank machining device, a tooth flank that forms a tooth space of a workpiece gear, the tooth flank machining device including: a first motor configured to rotate a grinding tool including a tool tooth portion having a thickness smaller than a width of the tooth space; a predetermined sensor configured to output a detection signal corresponding to a load of the first motor; a second motor configured to rotate the workpiece gear; and a control device configured to control the first motor, the tooth flank machining method comprising: causing the control device to acquire the detection signal; and causing the control device to control the first motor based on the detection signal to adjust a lead angle of the grinding tool relative to the workpiece gear in a manner so that the load in a case where the tooth flank of the workpiece gear during rotation is ground by the tool tooth portion falls within an allowable range determined in advance.

According to the present disclosure, a more satisfactory tooth flank machining device and a more satisfactory tooth flank machining method are provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a configuration diagram of a tooth flank machining device according to an embodiment of the present disclosure;

FIG. 2 is an enlarged view of a frame part in FIG. 1; and

FIG. 3 is a flowchart of a tooth flank machining method according to the embodiment.

### DETAILED DESCRIPTION OF THE INVENTION

There has been a demand for a technique that realizes stable finishing with a higher accuracy of the surface roughness of the tooth flank and a relatively small variation in the surface roughness while maintaining the tooth profile formed in the process before finishing. The load applied to the tooth flank during machining has a relatively large influence on the machining accuracy and the variation in surface roughness. Therefore, it is desirable that the load is stably maintained. According to JP 6030857 B2, the lead angle of a workpiece gear (a gear to be machined) relative to the helical teeth grinding wheel is controlled based on the rotational torque of the rotating shaft of the workpiece gear. However, intervening components such as a torsion buffer, a position coder, and a timing belt are disposed between the rotating shaft and a driving servo motor that drives the rotating shaft. The presence of these intervening components may deteriorate the detection accuracy of the rotational torque. The deterioration of the detection accuracy of the rotational torque adversely affects the machining accuracy of the workpiece gear.

Based on the above preliminary description, an embodiment of the present disclosure will be described below. Note that a program (a computer program, computer software) in the following description is also referred to as a computer program product. The computer program product is not limited to a program stored in a storage medium, and includes a program transmitted, distributed, or downloaded via a network such as the Internet.

### Embodiments

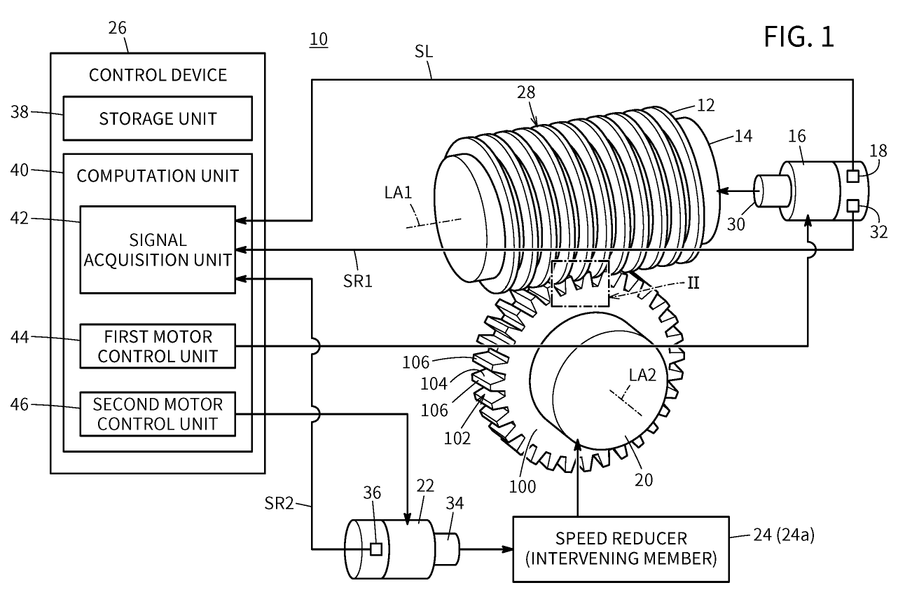

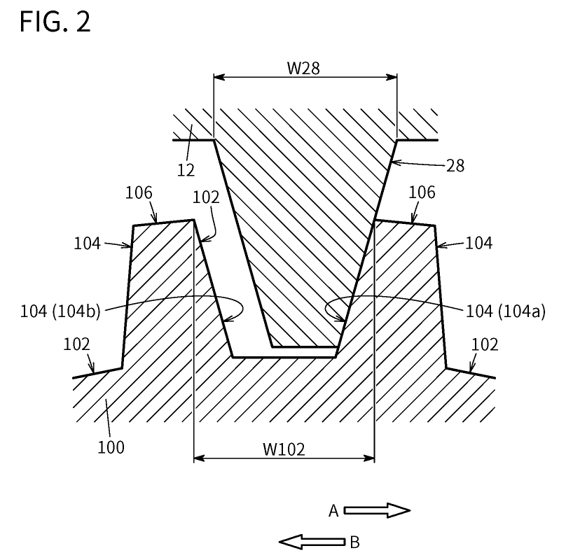

FIG. 1 is a configuration diagram of a tooth flank machining device 10 according to the embodiment. FIG. 2 is an enlarged view of a frame part in FIG. 1. An enlarged view of a frame II in FIG. 1 is shown in FIG. 2.

The tooth flank machining device 10 is a machining device that machines a tooth flank 104 of a workpiece gear (a gear to be machined) 100. As shown in FIG. 1, the tooth flank machining device 10 includes a grinding tool 12, a first shaft member 14, a first motor 16, a predetermined sensor 18, a second shaft member 20, a second motor 22, one or more intervening members 24, and a control device 26.

The workpiece gear 100 is a workpiece to be ground by the tooth flank machining device 10. For example, gears such as spur gears and helical gears are included in the workpiece gear 100. As shown in FIG. 2, the workpiece gear 100 includes a plurality of workpiece tooth portions (tooth portions to be machined) 106. Each of the plurality of workpiece tooth portions 106 is a tooth portion formed by roughing or the like performed in advance on a base material of the workpiece gear 100. A tooth space 102 (a plurality of tooth spaces 102) is (are) formed between the plurality of workpiece tooth portions 106. The tooth flank 104 is a surface of each of the workpiece tooth portions 106 that form the tooth space 102. In the following description, the tooth flank 104 of one of the two workpiece tooth portions 106 that form the same tooth space 102 is also referred to as a first tooth flank 104a, and the tooth flank 104 of the other of the two workpiece tooth portions 106 is also referred to as a second tooth flank 104b.

The grinding tool 12 is, for example, a grinding wheel. The grinding tool 12 includes a tool tooth portion 28. The tool tooth portion 28 is a tooth portion that abuts against the tooth flank 104 of the workpiece gear 100 in order to grind the tooth flank 104. The tool tooth portion 28 (the grinding tool 12) is preferably formed of an elastic material that is deformable along the shape of the tooth flank 104 of the workpiece gear 100. This can reduce the possibility of a grinding burn and a crack of the workpiece gear 100, a damage to the grinding tool 12, and the like. The tool tooth portion 28 has a worm thread shape (see also FIG. 1), but the present disclosure is not limited thereto. For example, the tool tooth portion 28 may have a helical tooth shape. The grinding tool 12 including the tool tooth portion 28 having a shape according to the needs can be appropriately provided in the tooth flank machining device 10.

A thickness W28 of the tool tooth portion 28 is smaller than a width W102 of the tooth space 102 (W28 < W102). Therefore, in the case where one of the first tooth flank 104a or the second tooth flank 104b abuts against the tool tooth portion 28, the other of the first tooth flank 104a and the second tooth flank 104b does not abut against the tool tooth portion 28 (see also FIG. 2).

The first shaft member 14 is a shaft member that supports the grinding tool 12. The first shaft member 14 is connected to a first shaft 30 of the first motor 16 described next (see also FIG. 1), and rotates integrally with the first shaft 30.

The first motor 16 is an electric motor that rotates the grinding tool 12. The first motor 16 is, for example, a spindle motor. The first motor 16 includes the first shaft 30 and a first encoder 32.

The first shaft 30 is a rotatable shaft. The rotation of the first shaft 30 causes the grinding tool 12 to rotate together with the first shaft member 14.

The first encoder 32 is a rotary encoder that outputs a detection signal corresponding to the rotational position of the first shaft 30. In the following description, the detection signal is also referred to as a first rotational position signal SR1.

Note that it is preferable that the grinding tool 12 is directly connected to the first shaft member 14, and the first shaft member 14 is directly connected to the first shaft 30. According to this feature, a first backlash is suppressed. The first backlash is a backlash between the grinding tool 12 and the first motor 16. By suppressing the increase in the first backlash, the first backlash is likely to be set smaller than a second backlash. The second backlash is a backlash between the workpiece gear 100 and the second motor 22 described later.

The predetermined sensor 18 outputs a detection signal corresponding to the load of the first motor 16. In the following description, the detection signal is also referred to as a load signal SL. The load of the first motor 16 is, for example, the rotational torque of the first shaft 30. The load of the first motor 16 increases as the tool tooth portion 28 of the grinding tool 12 is pressed against the tooth flank 104 of the rotating workpiece gear 100 more strongly. In other words, the load of the first motor 16 increases as the friction between the tool tooth portion 28 and the tooth flank 104 increases.

The predetermined sensor 18 is, for example, a torque meter, but is not limited thereto. The predetermined sensor 18 may be a sensor that detects a physical quantity having a causal relationship with a change in the rotational torque of the first shaft 30 (see also a second modification described later). For example, the first motor 16 rotates the grinding tool 12 pressed against the tooth flank 104 of the workpiece gear 100. In this case, a causal relationship can be found between a change in the rotational torque of the first shaft 30 and a change in a current flowing through the first motor 16, a change in a voltage applied to the first motor 16, or the like. Based on the causal relationship, the signal indicating the current or the voltage can be understood as a signal corresponding to the load of the first motor 16. Therefore, the predetermined sensor 18 may be, for example, a current sensor that detects a current flowing through the first motor 16, a voltage sensor that detects a voltage applied to the first motor 16, or the like.

The second shaft member 20 is a shaft member that supports the workpiece gear 100. The second motor 22 is an electric motor that rotates the workpiece gear 100 by rotating the second shaft member 20. The second motor 22 is, for example, a spindle motor. The second motor 22 includes a second shaft 34 and a second encoder 36.

The second shaft 34 is a rotatable shaft. The second shaft member 20 and the workpiece gear 100 rotate in accordance with the rotation of the second shaft 34.

The second encoder 36 is a rotary encoder that outputs a detection signal corresponding to the rotational position of the second shaft 34. In the following description, the detection signal is also referred to as a second rotational position signal SR2.

Regarding the first shaft member 14 and the second shaft member 20 described above, a first rotational axis LA1 and a second rotational axis LA2 are further shown in FIG. 1. The first rotational axis LA1 is a rotational axis of the grinding tool 12 (the first shaft member 14). The second rotational axis LA2 is a rotational axis of the workpiece gear 100 (the second shaft member 20). The first rotational axis LA1 and the second rotational axis LA2 may intersect each other.

The one or more intervening members 24 are members (a group of members) that are interposed between the second motor 22 and the second shaft member 20. The intervening members 24 include, for example, a speed reducer 24a disposed between the second motor 22 and the workpiece gear 100. The speed reducer 24a reduces the rotational speed of the second shaft 34 and transmits the reduced rotational speed to the workpiece gear 100. The speed reducer 24a may be provided in the second motor 22. Although not shown, a timing belt, a pulley, or the like may be disposed as the intervening member 24 between the second motor 22 and the second shaft member 20.

The control device 26 is an electronic device (a computer) that controls the first motor 16 and the second motor 22 to control grinding of the tooth flank 104 by the grinding tool 12. The control device 26 includes a storage unit 38 and a computation unit 40.

The storage unit 38 includes one or more memories. The storage unit 38 includes a non-volatile memory such as a read only memory (ROM), a flash memory, or a magnetic disk. The non-volatile memory is a storage medium that non-transitorily stores programs, tables, maps, and the like. At least part of the storage unit 38 may be realized by a portable storage medium such as a universal serial bus (USB) memory, a memory card, or an optical disk. The storage unit 38 may include a volatile memory such as a random access memory (RAM).

The computation unit 40 includes processing circuitry capable of executing arithmetic processing. The processing circuitry may include one or more processors. For example, the processing circuitry may include a central processing unit (CPU), a graphics processing unit (GPU), or the like. The processing circuitry may include an integrated circuit (IC) or a discrete device.

The computation unit 40 includes a signal acquisition unit 42, a first motor control unit 44, and a second motor control unit 46. The signal acquisition unit 42, the first motor control unit 44, and the second motor control unit 46 are realized by the above-described processing circuitry. For example, the signal acquisition unit 42, the first motor control unit 44, and the second motor control unit 46 are realized by a program stored in the storage unit 38 being executed by the processor of the computation unit 40. At least one of the IC or the discrete device described above may realize at least part of the signal acquisition unit 42, the first motor control unit 44, and the second motor control unit 46.

The signal acquisition unit 42 acquires the first rotational position signal SR1, the second rotational position signal SR2, and the load signal SL.

The first motor control unit 44 controls the first motor 16 based on the load signal SL acquired by the signal acquisition unit 42, thereby adjusting a lead angle of the grinding tool 12 relative to the workpiece gear 100. The lead angle of the grinding tool 12 relative to the workpiece gear 100 is a rotational phase difference of the grinding tool 12 from the workpiece gear 100. For example, a phase difference between certain rotational positions (reference positions) of the grinding tool 12 and the workpiece gear 100 can be specified as the lead angle.

As described above, the load of the first motor 16 increases as the tool tooth portion 28 is pressed against the tooth flank 104 more strongly. In view of this, the first motor control unit 44 performs feedback control on the first motor 16 based on the first rotational position signal SR1 so that the load of the first motor 16 indicated by the load signal SL falls within an allowable range, for example. As a result, the load of the first motor 16 falls within the allowable range. The allowable range is determined in advance based on experiments, simulations, and the like.

More specifically, in the case where the load of the first motor 16 is larger than the allowable range, the first motor control unit 44 adjusts the above-described lead angle in a direction in which the tooth flank 104 that is being ground by the tool tooth portion 28 is moved away from the tool tooth portion 28. On the other hand, in the case where the load of the first motor 16 is smaller than the allowable range, the first motor control unit 44 adjusts the above-described lead angle in a direction in which the tooth flank 104 that is being ground by the tool tooth portion 28 is caused to approach the tool tooth portion 28.

For example, in the example of FIG. 2, the first tooth flank 104a is being ground by the tool tooth portion 28. In this example, in the case where the load of the first motor 16 is larger than the allowable range, the first motor control unit 44 adjusts the above-described lead angle in a direction in which the friction between the first tooth flank 104a and the tool tooth portion 28 is reduced. This direction is a direction of arrow A in FIG. 2, in which the first tooth flank 104a is moved away from the tool tooth portion 28. As a result, the load of the first motor 16 decreases and falls within the allowable range. On the other hand, in the example of FIG. 2, in the case where the load of the first motor 16 is smaller than the allowable range, the first motor control unit 44 adjusts the above-described lead angle in a direction in which the friction between the first tooth flank 104a and the tool tooth portion 28 is increased. This direction is a direction of arrow B in FIG. 2, in which the first tooth flank 104a is caused to approach the tool tooth portion 28. As a result, the load of the first motor 16 increases and falls within the allowable range.

The second motor control unit 46 controls the second motor 22 to rotate the workpiece gear 100. The second motor control unit 46 may control the second motor 22 so that the rotational speed of the workpiece gear 100 becomes a target rotational speed determined in advance. In this case, the second motor control unit 46 may perform feedback control on the second motor 22 based on the second rotational position signal SR2 acquired by the signal acquisition unit 42. According to this feature, the rotational speed of the workpiece gear 100 is sequentially adjusted to the target rotational speed.

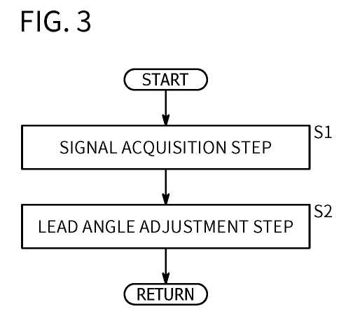

FIG. 3 is a flowchart of a tooth flank machining method according to the embodiment.

The tooth flank machining device 10 (the control device 26) can execute the tooth flank machining method shown in FIG. 3. The tooth flank machining method includes a signal acquisition step S1 and a lead angle adjustment step S2. Although not shown in FIG. 3, the second motor 22 is being controlled by the control device 26 (the second motor control unit 46) during the execution of the tooth flank machining method.

In the signal acquisition step S1, the control device 26 (the signal acquisition unit 42) acquires the load signal SL.

In the lead angle adjustment step S2, the control device 26 (the first motor control unit 44) controls the first motor 16 based on the load signal SL. As a result, the lead angle of the grinding tool 12 relative to the workpiece gear 100 is adjusted so that the load of the first motor 16 falls within the allowable range.

The tooth flank machining device 10 described above achieves the following operational effects, for example.

The workpiece gear 100 and the second motor 22 are relatively highly likely to be separated from each other by one or more intervening members 24 including the speed reducer 24a or the like for the purpose of, for example, increasing the rotational torque. Therefore, the second backlash tends to be set larger than the first backlash. The transmission efficiency of the force from the tooth flank 104 to the second motor 22 decreases as the second backlash increases. For this reason, the rotational torque of the second motor 22 is less likely to reflect a frictional force generated due to the tool tooth portion 28 being strongly pressed against the tooth flank 104. Therefore, it is not always easy to accurately determine, based on the rotational torque of the second motor 22, whether the abutment state between the tooth flank 104 and the tool tooth portion 28 during the grinding is appropriate. In contrast, in many cases, the grinding tool 12 (the first shaft member 14) and the first shaft 30 are arranged so as to be integrally rotatable. As a result, in many cases, the first backlash is set to be relatively small and smaller than the second backlash. For this reason, the transmission efficiency of the force from the tool tooth portion 28 to the first motor 16 is higher than the transmission efficiency of the force from the tooth flank 104 to the second motor 22. That is, the load of the first motor 16 is likely to reflect the frictional force (the torque applied to the tooth flank 104) generated due to the tool tooth portion 28 being strongly pressed against the tooth flank 104. In view of the above, according to the present embodiment, the control device 26 adjusts the lead angle of the grinding tool 12 relative to the workpiece gear 100 based on the load of the first motor 16. According to this feature, the tooth flank machining device 10 can appropriately adjust the abutment state between the tooth flank 104 and the tool tooth portion 28 during the grinding. Therefore, the tooth flank machining device 10 can achieve satisfactory machining accuracy.

The control device 26 controls the second motor 22 so that the rotational speed of the workpiece gear 100 becomes the target rotational speed determined in advance. The control device 26 can achieve satisfactory machining accuracy by continuously maintaining the rotational speed of the workpiece gear 100 to be constant to some extent.

The embodiment may be modified as described below, for example. In the following description, description overlapping with that of the embodiment will be appropriately omitted. Further, the reference numerals given to the respective elements in the embodiment denote the same elements in the following description.

### Modification 1

The first shaft 30 provided in the first motor 16 may also serve as the first shaft member 14 that supports the grinding tool 12. That is, the first shaft member 14 may be the first shaft 30. In this case, the grinding tool 12 is directly connected to the first shaft 30. By so doing, the friction between the grinding tool 12 (the tool tooth portion 28) and the workpiece gear 100 (the tooth flank 104) is more likely to be reflected in the load of the first motor 16. According to this feature, the control device 26 can more satisfactorily adjust the lead angle of the grinding tool 12 relative to the workpiece gear 100 based on the load of the first motor 16.

### Modification 2

The rotational torque of the first shaft 30 can be estimated based on the rotational speed, the rotational acceleration, and the like of the first shaft 30. Based on this, the first encoder 32 may also serve as the predetermined sensor 18. That is, the predetermined sensor 18 may be the first encoder 32. In this case, the control device 26 (the first motor control unit 44) uses, also as the load signal SL, the first rotational position signal SR1 used for the feedback control of the first motor 16. More specifically, the first motor control unit 44 estimates the rotational torque of the first shaft 30 based on the first rotational position signal SR1, and specifies the rotational torque as the load of the first motor 16.

In many cases, a motor such as a spindle motor is originally provided with a rotary encoder. Therefore, according to the present modification, it is not necessary to add a torque meter, a current sensor, a voltage sensor, or the like (see the embodiment) as the predetermined sensor 18. Therefore, the manufacturing cost, the component procurement cost, and the like of the tooth flank machining device 10 can be suppressed. Further, since it is not necessary to dispose a torque meter, a current sensor, a voltage sensor, or the like as the predetermined sensor 18, the degree of freedom in the layout of various components in the tooth flank machining device 10 can be secured.

The following supplementary notes are further disclosed in relation to the above-described embodiment.

### Supplementary Note 1

The tooth flank machining device (10) according to the present disclosure is a tooth flank machining device that grinds the tooth flank (104) that forms the tooth space (102) of the workpiece gear (100), the tooth flank machining device including: the first motor (16) configured to rotate the grinding tool (12) including the tool tooth portion (28) having the thickness (W28) smaller than the width (W102) of the tooth space; the predetermined sensor (18, 32) configured to output a detection signal corresponding to the load of the first motor; the second motor (22) configured to rotate the workpiece gear; and the control device (26) configured to control the first motor based on the detection signal to adjust the lead angle of the grinding tool relative to the workpiece gear in a manner so that the load in the case where the tooth flank of the rotating workpiece gear is ground by the tool tooth portion falls within the allowable range determined in advance. According to this feature, the tooth flank machining device can achieve satisfactory machining accuracy.

### Supplementary Note 2

In the tooth flank machining device according to Supplementary Note 1, the control device may control the second motor in a manner so that the rotational speed of the workpiece gear becomes the target rotational speed determined in advance. According to this feature, the tooth flank machining device can achieve more satisfactory machining accuracy.

### Supplementary Note 3

In the tooth flank machining device according to Supplementary Note 1 or 2, the grinding tool may be directly connected to the shaft (30) provided in the first motor. According to this feature, the tooth flank machining device can achieve more satisfactory machining accuracy.

### Supplementary Note 4

The tooth flank machining device according to Supplementary Note 1 or 2 may further include the speed reducer (24a) disposed between the second motor and the workpiece gear. According to this feature, the rotational torque of the workpiece gear can be increased.

### Supplementary Note 5

In the tooth flank machining device according to Supplementary Note 1 or 2, the first backlash that is a backlash between the grinding tool and the first motor may be smaller than the second backlash that is a backlash between the workpiece gear and the second motor. According to this feature, the tooth flank machining device can achieve satisfactory machining accuracy.

### Supplementary Note 6

The tooth flank machining method according to the present disclosure is a tooth flank machining method for grinding, using the tooth flank machining device (10), the tooth flank (104) that forms the tooth space (102) of the workpiece gear (100), the tooth flank machining device including: the first motor (16) configured to rotate the grinding tool (12) including the tool tooth portion (28) having the thickness (W28) smaller than the width (W102) of the tooth space; the predetermined sensor (18, 32) configured to output a detection signal corresponding to the load of the first motor; the second motor (22) configured to rotate the workpiece gear; and the control device (26) configured to control the first motor, the tooth flank machining method including: the signal acquisition step (S1) of causing the control device to acquire the detection signal; and the lead angle adjustment step (S2) of causing the control device to control the first motor based on the detection signal to adjust the lead angle of the grinding tool relative to the workpiece gear in a manner so that the load in the case where the tooth flank of the rotating workpiece gear is ground by the tool tooth portion falls within the allowable range determined in advance.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A tooth flank machining device that grinds a tooth flank that forms a tooth space of a workpiece gear, the tooth flank machining device comprising:
a first motor configured to rotate a grinding tool including a tool tooth portion having a thickness smaller than a width of the tooth space;
a predetermined sensor configured to output a detection signal corresponding to a load of the first motor;
a second motor configured to rotate the workpiece gear; and
a control device configured to control the first motor based on the detection signal to adjust a lead angle of the grinding tool relative to the workpiece gear in a manner so that the load in a case where the tooth flank of the workpiece gear during rotation is ground by the tool tooth portion falls within an allowable range determined in advance.

2. The tooth flank machining device according to claim 1, wherein
the control device controls the second motor in a manner so that a rotational speed of the workpiece gear becomes a target rotational speed determined in advance.

3. The tooth flank machining device according to claim 1, wherein
the grinding tool is directly connected to a shaft provided in the first motor.

4. The tooth flank machining device according to claim 1, further comprising a speed reducer disposed between the second motor and the workpiece gear.

5. The tooth flank machining device according to claim 1, wherein
a first backlash that is a backlash between the grinding tool and the first motor is smaller than a second backlash that is a backlash between the workpiece gear and the second motor.

6. A tooth flank machining method for grinding, using a tooth flank machining device, a tooth flank that forms a tooth space of a workpiece gear,
the tooth flank machining device including:
a first motor configured to rotate a grinding tool including a tool tooth portion having a thickness smaller than a width of the tooth space;
a predetermined sensor configured to output a detection signal corresponding to a load of the first motor;
a second motor configured to rotate the workpiece gear; and
a control device configured to control the first motor,
the tooth flank machining method comprising:
causing the control device to acquire the detection signal; and
causing the control device to control the first motor based on the detection signal to adjust a lead angle of the grinding tool relative to the workpiece gear in a manner so that the load in a case where the tooth flank of the workpiece gear during rotation is ground by the tool tooth portion falls within an allowable range determined in advance.
